(19) United States
(12) Patent Application Publication
(10) Pub. No.: US 2012/0265539 A1
(43) Pub. Date: Oct. 18, 2012

(54) CONTROL APPARATUS FOR AN ELECTRONIC DEVICE USING A BALANCED MICROPHONE CABLE

(76) Inventor: DAVID HILDERMAN, Victoria (CA)

(21) Appl. No.: 13/088,272

(22) Filed: Apr. 15, 2011

(51) Int. Cl. H04M 11/00

(52) U.S. Cl. 704/500

(57) ABSTRACT

This invention enables a microphone to control the device having the microphone input. it includes both ideas related to the microphone as well as the device with the microphone input. It utilizes a standard two conductor shielded microphone cable and does not impact the audio from the microphone when the control operation is being performed. The microphone produces common-mode signals which are detected by the device with the microphone input. These signals provide control of the device with the microphone input. Likewise the device with the microphone input produces common-mode signals which are detected by the microphone. These signals provide control of the microphone visual display indicators.

### RELATED APPLICATIONS

This application claims the benefit of U.S. Provisional Patent Application No. 61/328,162 filed in the United States Patent and Trademark Office on Apr. 26, 2010.

### FIELD OF THE INVENTION

This invention relates to the field of electrical audio signal processing systems and devices and specifically for a communication system using a standard two conductor shielded microphone cable.

### FEDERAL FUNDING

N/A

### BACKGROUND

Vocals in popular music often have effects applied to the sound. In order to control these effects, it is necessary for the user to interface with the effects processor. In a performance setting, the effects are either controlled by a sound engineer at the sound board, or by the singer using footswitches on a pedal based effects processor. This situation presents problems in that the singer needs to either rely on the engineer at the sound board to creatively control the vocal effects, or the singer needs to go to the pedal based effects processor to control the effect, Pedal based effects processors are the preferred compromise from a musically creative standpoint, but they require the singer to identify the foot control location on stage and activate in order to control the effect.

A much better solution would be to provide control of the effects processor on the microphone itself.

Professional microphones use a standard microphone cable to connect to the microphone input, comprising two conductors and a shield, The microphone couples the audio signal on to the two conductors as a differential-mode signal. Professional equipment microphone inputs have a differential-mode amplifier that amplifies the differential-mode audio signal to the required level. They often also have what is called phantom power, a voltage, usually +9 to +48 volts with respect to the shield, which is coupled equally to both conductors of the microphone cable. This phantom power is provided in order to power active electronics in microphones. FIG. 1 illustrates a typical prior art setup 10. The microphone 12 is connected to a receiving device 14 by a standard two conductor shielded microphone cable 16. The receiving device 14 can be a mixing console, an amplifier, an effects processor or a karaoke machine. Phantom power in the form of a DC voltage with respect to GND is supplied by the receiving device 14 to the microphone 12.

in the prior art, audio is singularly transmitted from the microphone to the receiving device. One problem associated with the prior art setup illustrated in FIG. 1 is that the microphone cannot be used to control the device having the microphone input. In order for the microphone to control the receiving device it would be necessary for the microphone to transmit both audio and control data to the receiver, Therefore, there is a continued requirement for a communications system permitting simultaneous communications of audio and data for a two conductor shielded microphone cable.

### SUMMARY OF THE INVENTION

The invention is a control apparatus for a transmitting device and a receiving device using a two conductor shielded microphone cable. The control apparatus comprises a communication system is provided for simultaneous signal transmission of both audio and data from the first to the second end of a two conductor shielded communications channel. The system comprises an first device at one end for balanced coupling of a data signal to both conductors of the communications channel at the transmitting device and utilizing the communications channel shield as ground reference, thereby transmitting a common-mode signal to the receiving device of the communications channel and for simultaneously coupling an audio signal through the two conductors of the communications channel as a differential-mode signal for transmission to the receiving device. At the receiving device of the communications channel is a second device for decoding the common-mode signal to recover the data signal for the purpose of controlling a function at the second device and for simultaneously decoding the differential-mode signal to recover the audio signal. The first device further comprises a user activated control to generate the data signal.

The device that transmits the audio may have the additional ability to receive data on aforementioned two conductor shielded communications channel using a common-mode method. The purpose of this data may be to control visual indicators on the device that transmits the audio for the purpose of indicating the status of the device receiving the audio.

The device that receives the audio may have the additional ability to transmit data on aforementioned two conductor shielded communications channel using a common-mode method. The purpose of this data. may be to report the status of the device receiving the audio.

The user activated control on the first device could be one or a combination of human interface device technologies including but not limited to switches, potentiometers, capacitive touch sensors, rotary controls, linear controls and accelerometers.

The visual indicators on the device that transmits the audio could be one or a combination of LED or LCD displays.

In one embodiment of the invention the first device comprises a dynamic microphone comprising a chassis, a microphone circuit contained within the chassis and a user activated control to generate a data signal. in one embodiment of the invention the user activated control is a switch circuit contained within the chassis of the microphone. The switch circuit comprises a control switch disposed on the chassis for control by a user.

### OBJECTIVES AND ADVANTAGES OF THE INVENTION

It is one objective of the invention to provide a user activated control apparatus for controlling an electronic device using a standard, two conductor shielded microphone cable

It is another Objective of the invention to provide a novel communication system injecting a common-mode signal representing data on a two conductor shielded microphone cable using the shield as a ground reference.

A further advantage of the present invention is the ability to control the device receiving the audio from the microphone with controls on the microphone chassis.

A further advantage of the present invention is the ability to communicate data from controlled device back to the microphone.

The microphone or first device in the invention can operate without the control feature with any professional audio equipment designed to work with a similar microphones not having the control feature.

The second device in the invention can operate without the control feature with any professional audio equipment or microphone not having the control feature.

Another advantage of the invention is that is uses low cost circuitry,

### DESCRIPTION OF THE DRAWINGS

FIG. 1 is a prior art schematic drawing of a microphone attached to a device.

FIG. 2 is a generalized block diagram illustrating a specific embodiment of a system according to the invention.

FIG. 3 is a detailed schematic diagram illustrating a specific embodiment of the first device circuit shown in FIG. 2 according to the invention.

FIG. 4 is a detailed schematic diagram illustrating a specific embodiment of the second device circuit shown in FIG. 2 according to the invention.

FIG. 5 is a detailed schematic diagram illustrating a another specific embodiment of the first device circuit shown in FIG. 2 according to the invention.

FIG. 6 is a detailed schematic diagram illustrating another specific embodiment of the second device circuit shown in FIG. 2 according to the invention.

FIG. 7 is a detailed schematic diagram illustrating a another specific embodiment of the first device circuit shown in FIG. 2 according to the invention.

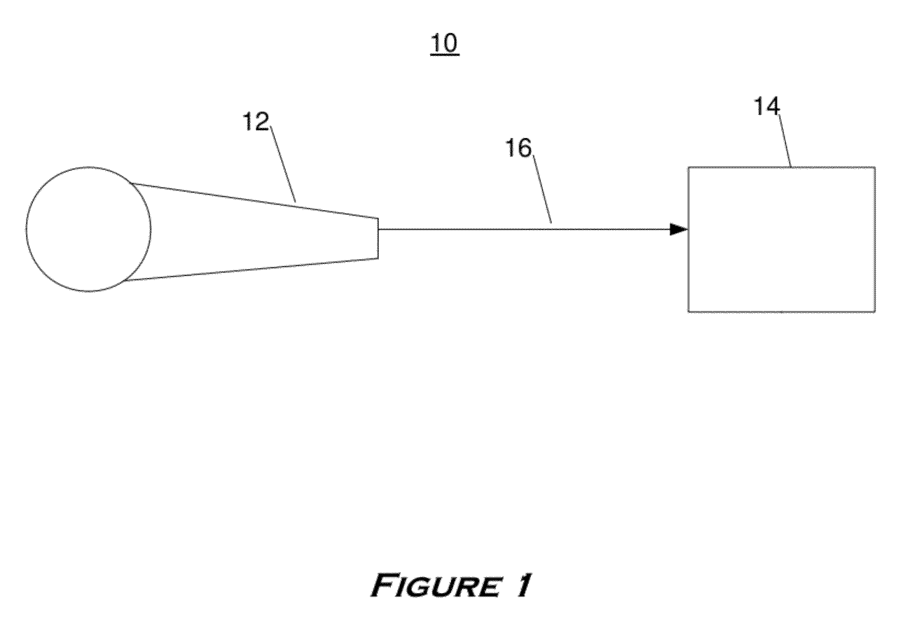

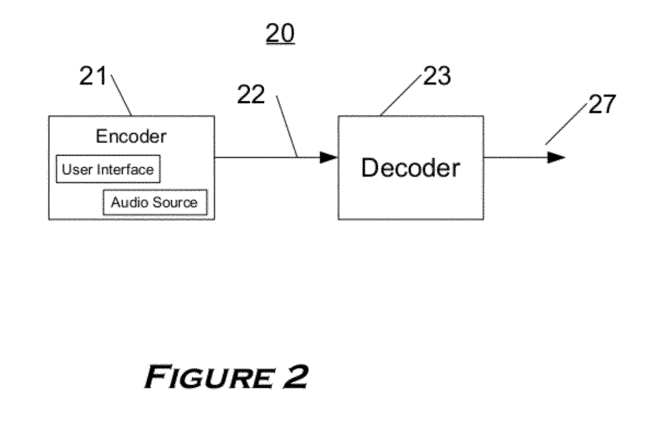

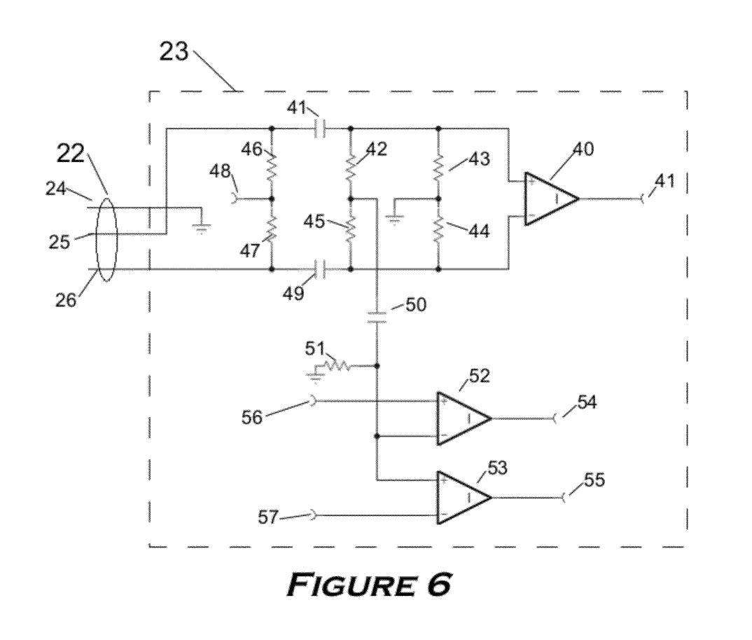

FIG. 6 is a detailed schematic diagram illustrating another specific embodiment of the second device circuit shown in FIG. 2 according to the invention.

### DESCRIPTION OF THE INVENTION

The invention is a control apparatus for using a standard two conductor shielded microphone cable connected between the first device and the second device. It is to be understood that the first device can be any type of user activated first device that can generate both an audio signal and a data signal in a standard two conductor shielded microphone cable The user activated control could be one or a combination of human interface device technologies including but not limited to switches, potentiometers, capacitive touch sensors, rotary controls, linear controls and accelerometers, in the description that follows, the one embodiment of the invention is exemplified using a microphone.

In the music industry, a very common device is a microphone. The microphone is an ideal instrument for an first device as it is connected to the second device a using a two conductor shielded microphone cable. A circuit, in the form of a user activated control can be installed on the microphone circuit and enclosed within the microphone chassis. The user activated control can comprise one or a combination of human interface device technologies including but not limited to switches, potentiometers, capacitive touch sensors, rotary controls, linear controls and accelerometers, thereby generating a data signal as more fully described below. The human interface technology can be installed on the microphone chassis. Devices that receive the data signal on the standard two conductor shielded microphone cable could also pass on the data signal along with an audio signal on its outputs to subsequent devices using standard microphone cables. In response to receiving the data from the microphone the, receiving device could generate response data in response to the data signal received to be received by the microphone.

For the sake of explanation of the invention, a particular embodiment has been selected comprising a microphone as the first device. This is not intended to restrict the invention to microphones.

in one embodiment of the first device, the first device has the ability to transmit both data and audio on a standard microphone cable.

In another embodiment of the first device, the first device has the ability to transmit both data and audio on a standard microphone cable as well as receive data on the microphone cable.

In one embodiment of the second device, the second device has the ability to decode both data and audio on a standard microphone cable.

In another embodiment of the second device, the second device has the ability to decode both data and audio on a standard microphone cable as well as transmit data on the microphone cable.

FIG. 2 is a generalized block diagram illustrating the control apparatus 10 providing communications of both audio and data from the first device 21 to the second device 23 using a standard two conductor shielded microphone cable 22, where the first device chassis houses circuitry to produce the audio signal as well as a user interface and circuitry to produce the data signal. The system is capable of concurrent transmission of audio of any source along with data. of any source from the first device through the standard two conductor shielded microphone cable to the second device.

The first device 21 may be a microphone, a musical instrument, an effects processor, a control interface or any device that houses a connector to accept a two conductor shielded microphone cable intended for audio output. The second device 23 may be a mixing console, an amplifier, an effects processor a karaoke machine or any device that houses a connector to accept a two conductor shielded microphone cable intended for audio input.

In one embodiment the first device 21 is a microphone with user controls used by a singer and the second device 23 is a. multi-effects audio signal processor. In operation the singer would sing in to the microphone and when artistically desired, change the effects applied by the multi-effects processor by activating the user controls while singing.

In another embodiment the first device 21 is a microphone with user controls used by a singer and the second device 23 is a multi-effects audio signal processor. In operation the singer would sing in to the microphone and when artistically desired, change the effects applied by the multi-effects processor by activating the user controls while singing. The second device would send data to the first device in order for the first device to activate visual indicators in response to the data sent by the first device. A singer then could activate user controls on the microphone for the purpose of changing the operation of the effects processor, then by looking at the visual indicators on the microphone acknowledge the status of the effects processor. If a user presses a control on the microphone to activate an effect in the multi-effects processor, the user could then visually verify that the effect was activated by the status of the visual indicators on the microphone.

Normally the singular transmission of audio would be possible through the microphone cable 22 from the first device 21 to the second device 23. However, with the invention, data may be injected by the first device 21 as a common-mode signal on the cable 22 via a balanced input thereby transmitting the data to the second device 23. The second device 23 detects decodes) the common-mode signal and uses the resultant data to control functions within the second device. Thereby the transmission of both audio and data is realized from the first device to the second device through a standard two conductor shielded microphone cable 22.

This permits the singer to control functions of the multi-effects processor while using the microphone to capture the audio from the singers voice.

In addition the second device 23 could inject response data as a common-mode signal on the cable 22 thereby transmitting the data to the first device 23. The first device 21 then could detect the common-mode signal and uses the resultant data to activate status indicators on its visual indicators.

The output 27 of the second device 23 is the conventional output which is recorded, broadcast, amplified etc. In the case where the second device 23 houses loudspeakers in its chassis, the output is not required.

The system of FIG. 2 may be used to control numerous functions in the second device 23. For example activating a switch on the first device 21 at a constant rate could be interpreted at the second device to set the tempo of a tempo based effect. Other examples include activating a switch on the first device to mute the audio output of the second device or activating a switch on the first device to activate an effect on the second device such as harmony voices or reverb or flanging or auto correction or delay effects or rhythmic effects.

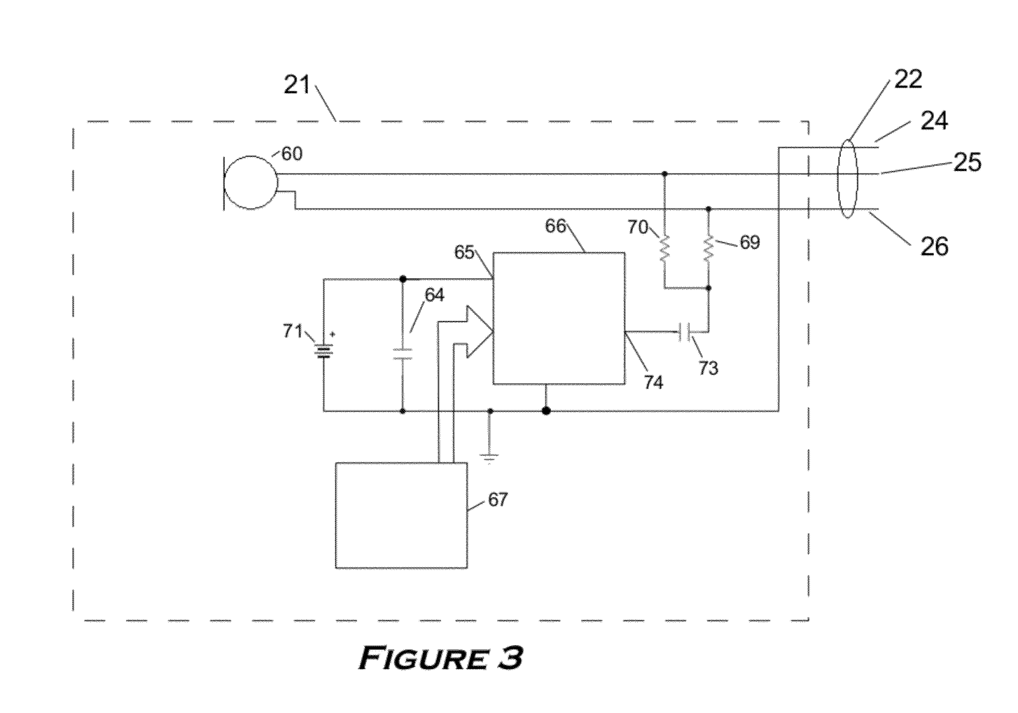

Referring now to FIG. 3 there is shown a detailed schematic diagram of the first device 1 according to the invention. The microphone cable 22 comprise two conductors 25, 26 and a conductive shield 24, as shown. The audio signal from the microphone 60 is coupled across the conductors 25, 26 as a differential-mode signal and is transmitted down the cable to the second device 23 (see FIG. 2). in the first device 21 common ground reference is provided by connection to the shield 24 and power is provided by a battery 71 conditioned by capacitor 64 and coupled to the voltage source input 65 of the microprocessor 66. in the first device 21 human interface device technologies 67 provide input as a function of the user input to a microprocessor 66. The output of the microprocessor is coupled across conductors 25, 26 through capacitor 73 and two equal value resistors 69, 70, as shown. A data signal is output at the microprocessor data output 74 as a function of the user input to the human interface device technologies 67. As a result, user input on the first device 21 through the human interface device technologies 67 causes a data signal to be produced by the microprocessor and this data signal is then injected by a common-mode method (not interfering with the normal transmission of audio from the first device to the second device) onto the cable and transmitted to the second device. This data signal is injected in common-mode (i.e. in phase) equally on both conductors 25, 26. The embodiment of FIG. 3 is one of many circuit configurations which may be constructed to encode the common-mode data signal and encode the differential-mode audio signal on the cable 22.

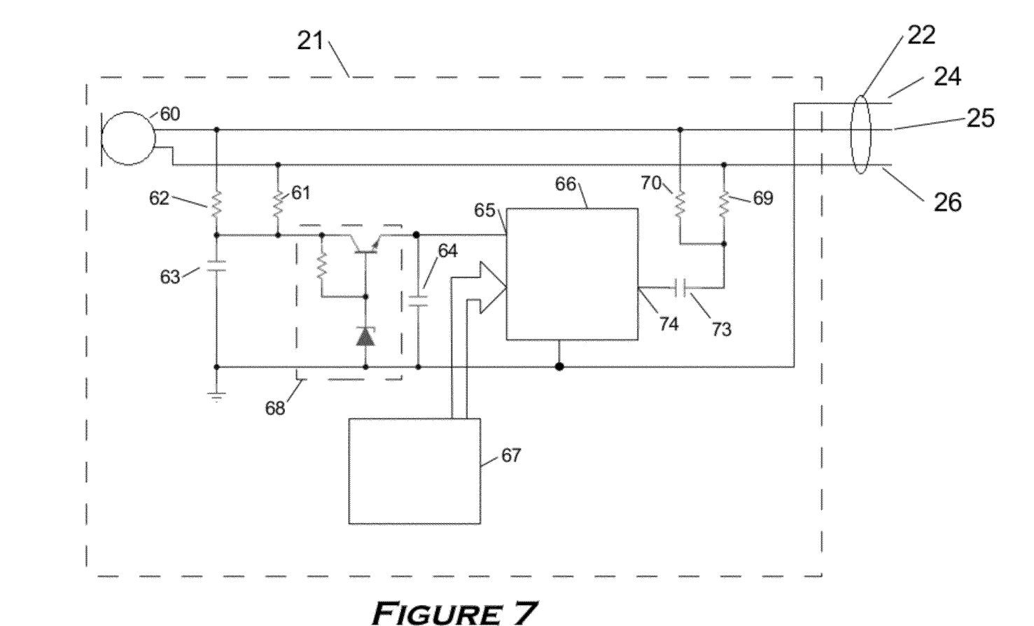

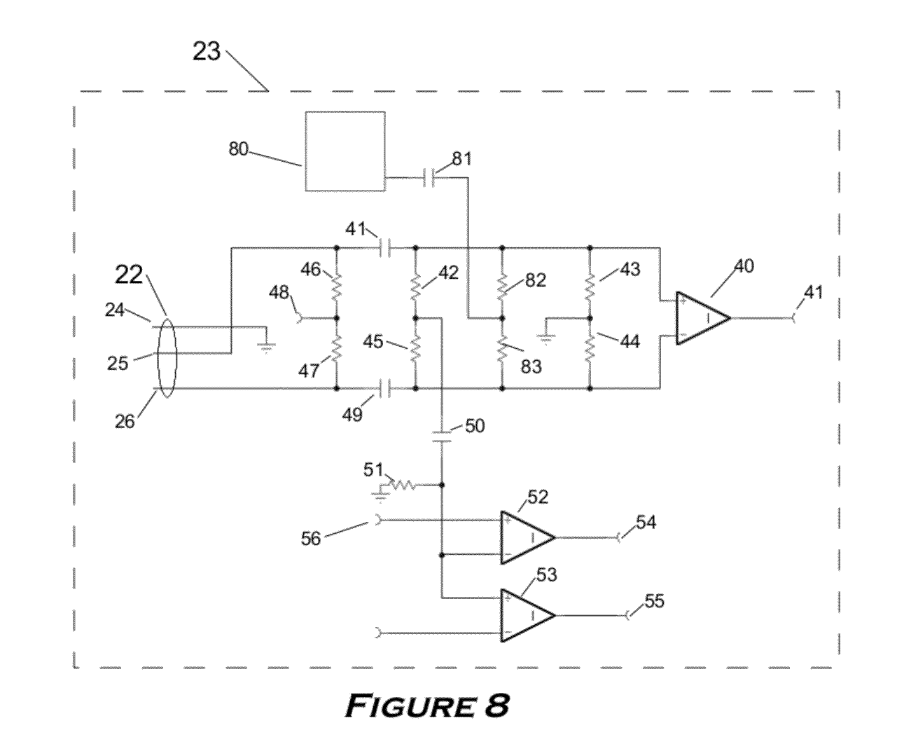

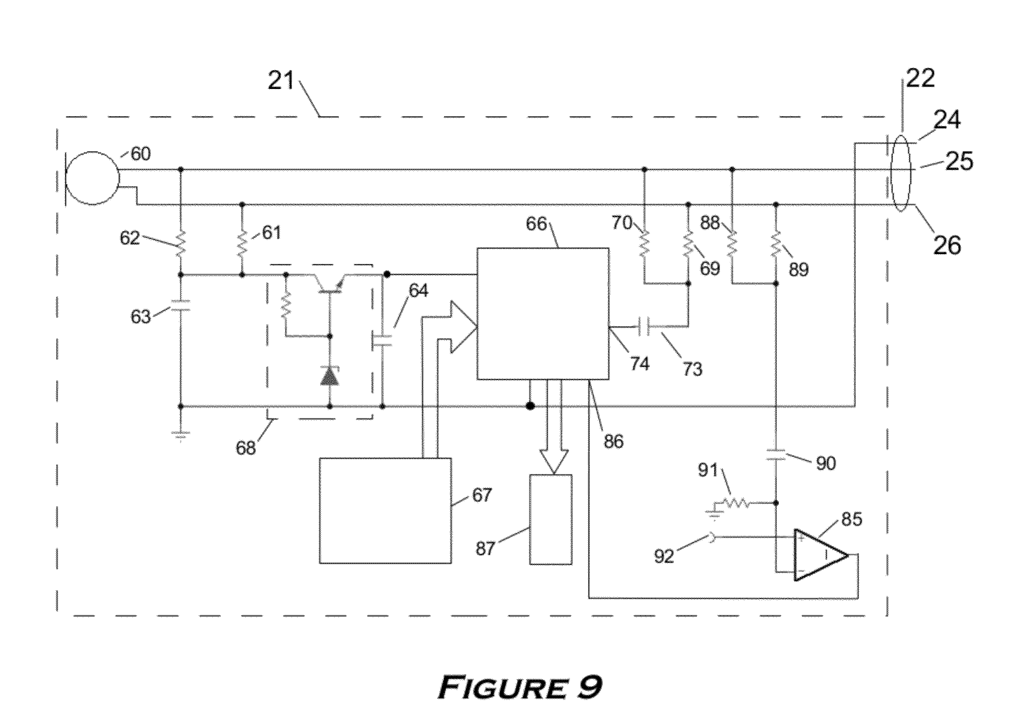

A detailed schematic diagram illustrating an alternative configuration is shown in FIG. 7. This configuration is similar to the embodiment of FIG. 3 except that no battery is required. This configuration is used when a common-mode DC voltage (phantom power) is applied to the cable at the second device end using the shield as ground reference. The primary difference from FIG. 3 is that the DC voltage on the cable is coupled from the conductors 25, 26 through the resistors 62, 61 then filtered by a by-pass capacitor 63 and then regulated to the voltage required by the microprocessor 66 by a conventional voltage regulation circuit 68 and then is applied to the microprocessor voltage source input 65.

A detailed schematic diagram illustrating an alternative configuration of the first device 21 is shown in FIG. 9. This configuration is similar to the embodiment of FIG. 7 but in addition, in the first device 1, two equal value resistors 88, 89 are coupled across two conductors 25, 26 as shown. The common connection of resistors 88, 89 is coupled through capacitor 90 then through resistor 91 to the cable shield 24 as common ground and the negative (−) input to the comparator 85 as shown. Capacitor 90 and resistor 91 provide filtering. A reference voltage 92 is coupled to the positive (+) input to the comparator 85. The common-mode data signal is decoded and output by the comparator 85 and coupled to an input of the microprocessor 66 at connection 86. The microprocessor 66 is coupled to the visual indicators 87.

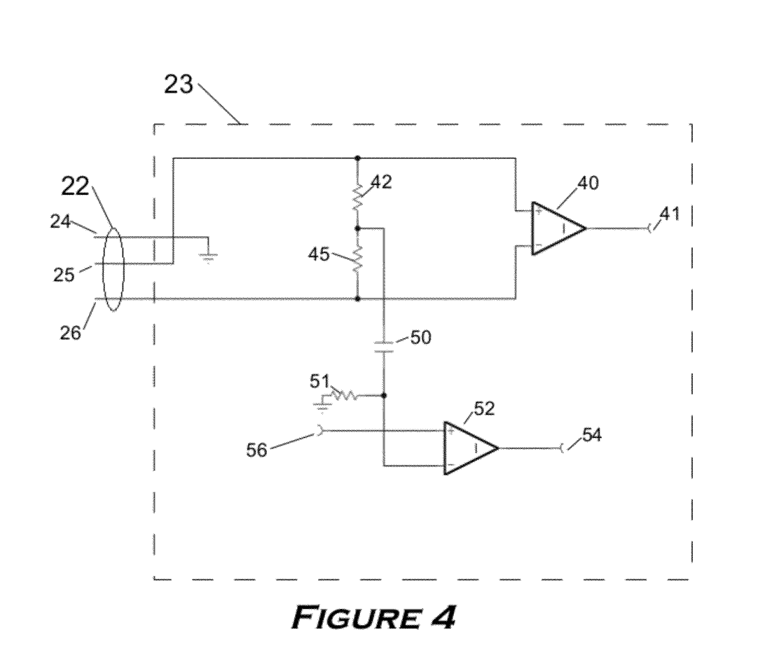

Referring now to FIG. 4, there is shown a detailed schematic diagram of the second device 23 according to the invention. The microphone cables 22 comprise two conductors 25, 26 and a conductive shield 24, as shown. in the second device 23, common ground reference is provided by connection to the shield 24. Power for the amplifier 40 and the comparator 52 is derived from the power supply within the second device. The two conductors 25, 26 are coupled to the differential inputs of the amplifier 53. The differential-mode signal is decoded by the amplifier 40 to an audio signal and is coupled to the amplifier output 41. The audio signal is used by the second device as required. in the second device 23, two equal value resistors 42, 45 are coupled across two conductors 25, 26 as shown. The common connection of resistors 42, 45 is coupled through capacitor 50 then through resistor 51 to common ground and the negative (−) input to the comparator 52 as shown. Capacitor 50 and resistor 51 provide filtering. A reference voltage 56 is coupled to the positive (+) input to the comparator 52. The common-mode data signal is decoded and output by the comparator 52 at the comparator output terminal 54. Thus the second device circuit 23 decodes both the differential-mode audio signals and common-mode data signals as applied to the lines 25 and 26 using the shield as a ground reference. The embodiment of FIG. 4 is one of many circuit configurations which may be constructed to decode the common-mode data signal and decode the differential-mode audio signal on the cable 22.

A detailed schematic diagram illustrating an alternative configuration of the second device is shown in FIG. 6. This configuration is similar to the embodiment of FIG. 4 but couples a DC voltage (i.e. 9-50V) to power devices at the other end of the cable is coupled to terminal 48 through resistors 46, 47 to conductors 25, 26 with the shield 24 functioning as a ground reference. Capacitors 41 and 49 and resistors 43 and 44 block the DC voltage from the input to the amplifier 40. In addition, a comparator 53 is added along with an appropriate reference voltage to allow detection of a shift down in common-mode signal, followed by time greater than 20 milliseconds and shift up in common-mode signal, allowing inexpensive circuitry in the first device 21. A common-mode shift down is decoded at terminal 54 as a. positive pulse. A common-mode shift up is decoded at terminal 55 as a positive pulse.

A detailed schematic diagram illustrating an alternative configuration of the second device 23 is shown in FIG. 8. This configuration is similar to the embodiment of FIG. 6, but couples an additional data signal output by the microprocessor 80 as a common-mode signal to conductors 25, 26 with the shield 24 functioning as a ground reference. through capacitor 81 and resistors 82 and 83. Power for the microprocessor 80 is derived from the power supply within the second device.

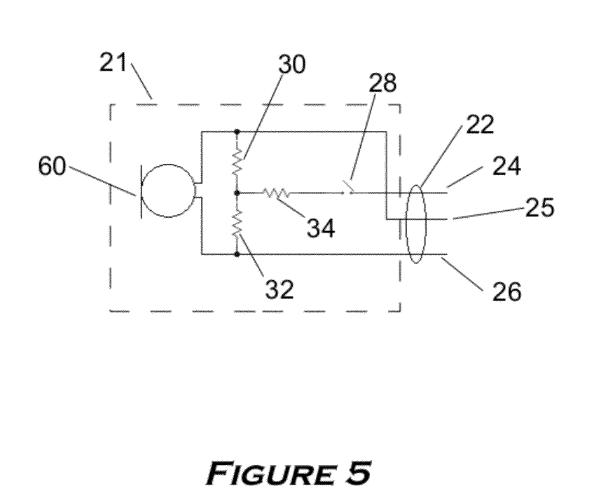

Referring now to FIG. 5 there is shown a detailed schematic diagram of another embodiment of the first device 21 according to the invention. The microphone cable 22 comprise two conductors 25, 26 and a conductive shield 24, as shown. The audio signal from the microphone 60 is coupled across the conductors 25, 26 as a differential-mode signal and is transmitted down the cable to the second device 23 (see FIG. 2). This embodiment is used when a common-mode DC voltage (phantom power) is applied to the cable at the second device end using the shield as ground reference. The conductors 25,26 are coupled through resistors 30 and 32 to switch 28 through resistor 34. The other side of the switch is coupled to the shield 24. Closing the switch produces a balanced shift down in voltage on both conductors 25, 26 with respect to the shield ground 24. Opening the switch produces a balanced shift up on conductors 25, 26 with respect to the shield ground 24. The common-mode data signal in this embodiment is a simple common-mode shift down in voltage of the cable conductors with respect to ground when the user closes the switch and a simple shift up in common-mode voltage when the user opens the switch.

While one or more embodiments of the present invention have been illustrated in various degrees of detail, the skilled artisan will appreciate that modifications and adaptations to those embodiments may be made without departing from the scope of the present invention as set forth in the following claims.

1. A control apparatus for providing simultaneous signal transmission of both audio and data signals from the first to the second end of a two center conductor shielded communications channel comprising:
a first device for balanced coupling of a data signal to both center conductors of the communications channel at the first end thereof utilizing the communications channel shield as ground reference, thereby transmitting a common-mode signal to the second end thereof and for simultaneous differential coupling of an audio signal to the center conductors of the communications channel at the first end, thereby transmitting a differential-mode signal to the second end; and,
a second device for coupling to the second end of the communications channel for receiving said common-mode signal to recover the data signal to be used to control functions in said second device and for simultaneously decoding the differential-mode signal to recover the audio signal.

2. The system of claim l wherein the first device comprises a human interface used to generate the data signal.

3. The system of claim 2 wherein said human interface comprises at least one of the following to generate the data signal: switches, potentiometers, capacitive touch sensors, rotary controls, linear controls and accelerometers.

4. The system of claim 1 wherein the first device comprises a microprocessor to generate the data signal.

5. The system of claim 1 wherein the first device comprises a microphone for supplying the differential audio signal.

6. The system of claim 1 wherein the first device comprises a self-contained power source for said microprocessor.

7. The system of claim 1 wherein the second device couples a DC voltage to the center conductors of the communications channel.

8. The system of claim 7 wherein the first device further comprises means for deriving power from said DC voltage for the microprocessor.

9. The system of claim 7 wherein the first device further comprises a resistor network through a switch to shield ground to generate the common-mode signal.

10. The system of claim 1 wherein the second device further comprises an audio signal processor for receiving said audio signal.

11. The system of claim 1 wherein the second device further comprises means for balanced coupling of a response data signal to both center conductors of the communications channel at the second end thereof utilizing the communications channel shield as ground reference thereby transmitting a common-mode response data signal to the first device.

12. The system of claim 11 wherein the first device further comprises means for coupling to the first end of the communications channel for decoding the said common-mode response data signal to recover said response data signal from the second end thereof.

13. The system of claim 12 wherein the first device further comprises visual indicators functioning in response to the response data signal.
